(19) United States
(12) Patent Application Publication
(10) Pub. No.: US 2024/0219245 A1
(43) Pub. Date: Jul. 4, 2024

(54) TEST ARRANGEMENT AND TEMPERATURE SENSOR

(71) Applicant: TDK Electronics AG, München (DE)

(72) Inventors: Markus Wehring, Potsdam (DE); Conall Dodd, Berlin (DE); Jordi Basiana Martí, Berlin (DE); Carsten Dehoff, Berlin (DE); Bernhard Ostrick, Teltow (DE)

(21) Appl. No.: 18/556,085

(22) PCT Filed: Apr. 26, 2022
(86) PCT No.: PCT/EP2022/061081

§ 371 Date: Oct. 18, 2023

(30) Foreign Application Priority Data
Apr. 27, 2021 (DE) 102021110764.4

(51) Int. Cl. G01K 7/22; G01K 1/08; G01K 1/14; G01K 1/16

(52) U.S. Cl. CPC G01K 7/223; G01K 1/08; G01K 1/14; G01K 1/16

(57) ABSTRACT

The invention relates to a test arrangement comprising a test body and a temperature sensor for measuring the temperature thereof, as well as a correspondingly suitable temperature sensor. In the test arrangement, a temperature sensitive element of the temperature sensor is at least partially recessed into a recess in the test body by insertion into the recess.

### CROSS-REFERENCE TO RELATED APPLICATIONS

This application is a U.S. National Stage of International Application No. PCT/EP2022/061081, filed Apr. 26, 2022, which claims the benefit of Germany Patent Application No. 102021110764.4, filed Apr. 27, 2021, each of which is incorporated by reference herein in its entirety.

The invention relates to a test arrangement comprising a test body and a temperature sensor for measuring the temperature thereof, as well as a correspondingly suitable temperature sensor.

In many applications, the temperature measurement of test bodies, such as on power rails in electric motors in electric vehicles or on pipes of air conditioners or heat pumps, is of great technical importance. In principle, care must be taken to ensure a good thermal connection of a temperature sensor to the test body.

Temperature sensors as described prior to the present invention, such as disclosed in U.S. Pat. No. 10,436,648 B2, DE 102017222543 or German utility model DE 20 2020 101 413 U1, are usually pressed externally onto surfaces of electrical components whose temperature is to be measured. Alternatively, as described in EP 2830179 A2, temperature sensors can in principle also be attached to the surface of a component to be tested by adhesive bonding.

According to the present invention, a test arrangement and a temperature sensor are provided, which enable a simple and mechanically stable installation of the temperature sensor in the test arrangement.

According to a first embodiment, a test arrangement is provided comprising a test body and a temperature sensor for measuring the temperature thereof. The test body has a recess open towards its insertion side. The temperature sensitive element of the temperature sensor is at least partially recessed into the recess by insertion.

Here and in the following, insertion is preferably understood as a mainly rotation-free movement or a manly translatory movement into the recess. Accordingly, preferably no screwing of a part of the temperature sensor recessed into the recess takes place. In particular, preferably no screwing of the recessed or partially recessed part of the temperature sensor into the recess takes place. Accordingly, preferably neither the recess nor the part of the temperature sensor that is or will be recessed into the recess has a thread.

A corresponding test arrangement or temperature sensor has the advantage that it is easy to attach the temperature sensor to the test body. For example, attaching the temperature sensor does not require any tools for screwing it in.

At the same time, at least partial recessing in the test body has the advantage that slippage of the temperature sensor perpendicular to an insertion direction is inhibited by the walls of the recess. Thus, slippage parallel to a surface of the test body can also be inhibited. By restricting the movements of the sensor, position assurance can be achieved. Thus, sensitivity to vibrations or the like can be reduced and the safety and accuracy of measurements can be increased. This is particularly relevant with respect to a long-term or continuous measurement of temperature.

Furthermore, the at least partial recessing of the temperature-sensitive element allows heat exchange or heat flow from the test body to the temperature-sensitive element from several spatial directions. The greater the number of directions from which heat flows to the temperature sensitive element or, in the case of cooling, in which it flows away, the faster the temperature of the temperature sensitive element can be brought into line with the temperature of the test body. Thus, the temperature detection can be improved.

For example, in conventional test arrangements in which the sensor is applied to the outside of the test body, heat flow occurs only on one side. In contrast, a temperature sensor according to the invention and a test arrangement according to the invention allow a faster heat exchange.

Even if the temperature sensitive element hangs completely free in the recess and there is no direct contact with the test body, the fact that it is partially recessed and thus at least partially enclosed means that sufficient heat exchange can take place even in the presence of an air layer between a wall of the recess and the temperature sensitive element. A direct physical contact to the temperature sensitive element or an outer cover is not necessary. Also a loose contact of the temperature sensitive element with the walls of the recess can have a smaller influence on the temperature measurement than for a case of an only externally applied sensor.

As the test body at least partially surrounds the temperature sensitive element, heat dissipation from the temperature sensitive element to the environment can be reduced. In this way, unlike in a sensor that is only externally applied, a systematic temperature difference between the temperature sensitive element and the test body can be at least partially prevented.

In one embodiment, according to the present invention, the temperature sensitive element or a cover surrounding it may be in direct contact with the walls of the recess. Alternatively, the temperature sensitive element may be free-hanging or free-standing in the recess. Direct contact with the wall may be advantageous for rapid detection of temperature changes.

Preferably, the test body contains a solid-like material. Preferably, the recess is formed in the solid-like material.

If the recess penetrates the test body from an insertion side to a further side of the test body, the temperature sensitive element is preferably recessed into the recess in such a way that it does not protrude from the recess on the further side.

For example, the test body here can be a power rail, for example in an electric motor in electric vehicles. Thus, the test body can be made of metal, for example.

Alternatively, the test body can also be a tube of an air conditioner or a heat pump or another tube. In this case it is preferable, if the recess is formed exclusively in the pipe wall. It is preferred that the temperature sensor does not penetrate into a pipe interior, for example, does not reach into a fluid that is guided in a pipe. Alternatively, the test body may be a cantilever on one of the above bodies. In this context, cantilever can be understood as a part projecting from a main body.

It is preferred that the temperature sensitive element is completely recessed in the recess.

Complete recessing can further improve the exchange of heat.

Complete recessing can further reduce heat dissipation from the immediate vicinity of the temperature sensitive element and from the temperature sensitive element itself to the surrounding environment.

A temperature sensor described above preferably contains the temperature sensitive element in a measuring head, the measuring head preferably having a cover.

In particular, a measuring head can be more mechanically stable than the temperature sensitive element itself. This allows the temperature sensitive element to be protected from mechanical stress. In addition, inhibiting movement perpendicular to the insertion direction by having inserted the measuring head with the temperature sensitive element is also more feasible than with a comparatively unstable exposed temperature sensitive element alone.

According to another embodiment, a fastening device for fixing the temperature sensor for movement against the insertion direction may be included in the test arrangement.

By the combination of the inhibition of movement by the partially recessed temperature sensor and the fastening device, movement or displacement of the temperature sensor against the test body in all spatial directions can be largely inhibited or suppressed.

According to an embodiment, the fastening device comprises a spring clamp.

Preferably, the spring clamp causes a certain contact pressure between the temperature sensor and the test body, which mainly has the task of preventing the temperature sensor from falling out of the recess in the direction opposite to the insertion direction or from falling off the test body.

As a result of this design of the test arrangement, the clamp does not necessarily have to prevent displacement or slippage perpendicular to the insertion direction. It is therefore sufficient if a tolerance requirement for the clamping effect is lower than in a case in which the clamp would also have to act against displacement or slippage perpendicular to the insertion direction.

Preferably, parts of the temperature sensor, which may be referred to as a so-called holding region of the temperature sensor, such as parts of a temperature sensor housing or parts of the spring clamp, rest on the test body near the recess. Thus, the spring clamp can provide a clamping effect between a part of the spring clamp facing away from the holding region and the holding region.

A spring clamp as a fixation can have the particular advantage that it can be designed as part of the temperature sensor. For example, the temperature sensor can thus be attached to the test body by means of a simple push-on-and-in-operation, wherein the temperature sensitive element becomes at least partially recessed in the recess and the spring clamp engages the temperature sensor in such a way as to produce the clamping effect. Additional attachment of a separate spring clamp, separated from the rest of the temperature sensor, after insertion of the temperature sensitive element can thus be avoided. Furthermore, a spring clamp can avoid complicated screwing on or screwing in, since fastening and fixing can be done by simply plugging on and in.

In particular, a single or multiple spring clamps can provide the fixation. In the case of a single spring clamp, the temperature sensor can also be attached to a test body that is not accessible from all sides, for example because access is blocked from some sides due to installation in an application.

Multiple spring clamps, such as two spring clamps, for example, can provide multi-sided and thus more secure fixation.

The spring clamp can, for example, be made of an elastic metal or an elastic polymer.

The spring clamp can be made of a similar or the same material as the housing. However, the material can also be different.

According to a further embodiment, a cable tie may be used as an alternative to or cumulative with the spring clamp to secure the temperature sensor.

The cable tie can, for example, be attached around the test body and the temperature sensor. It can therefore wrap around the test body and temperature sensor together, or be pulled tight around them. A cable tie can be a simple and inexpensive fixation means. In particular, the cable tie can be attached to an elongated test body at a point where the test body is free all around with respect to its longitudinal axis.

According to another embodiment, the recess is a blind hole.

Since the blind hole has a bottom opposite the insertion side, the temperature sensitive element can also be surrounded by the material of the test body on the side of this bottom in addition to the wall of the recess. This prevents heat from escaping from the recess to the environment even better and further improves the temperature measurement.

Also for a blind hole the following applies: the temperature sensitive element or its measuring head can be in contact with the walls or the floor, but it does not have to be.

Alternatively, however, the recess may have another opening on the outside of the test body in addition to the opening on the insertion side. This may, for example, be a continuous opening through the test body, with the opening being on the opposite side of the insertion side, for example. In this case, it is preferred that the temperature sensor has a sealing component that at least partially covers this further opening.

A continuous opening in the test body is in some cases easier to produce than a blind hole. For example, an inexpensive punching process can be used for this purpose.

In an embodiment, this additional opening is completely covered.

This means that heat can be prevented from escaping from this additional opening, for example via convection, thus achieving an effect similar to that of the blind hole.

Preferably, such a sealing component can be part of a spring clamp, which is advantageous in particular if it spans the test body from a connecting part or middle part of the temperature sensor housing and rests on the side opposite the insertion side.

For example, a flattened portion of the spring clamp or a contact surface of the spring clamp may provide a such a cover or, more preferably, closure thereof.

According to another embodiment, the temperature sensor at least partially covers the recess on the insertion side of the test body.

According to an embodiment, the test body completely covers the opening of the recess on the insertion side.

By at least partially covering the opening on the insertion side, the recess can be additionally closed off as a space for temperature measurement. This can reduce a loss of heat from the recess and thus enable a more accurate temperature measurement.

According to another embodiment, also a contact agent having better thermal conductivity than air may at least partially fill a space between the outside of the temperature sensitive element and the walls of the recess.

According to an embodiment, the contact agent may be, for example, a thermal paste.

A contact agent that at least partially replaces the air in the recess can improve thermal conduction between the temperature sensitive element and the walls of the recess in the test body. This can make a temperature measurement even more accurate or even faster. Faster here can mean that a temperature change in the test body can be detected more quickly by the temperature sensitive element. This can be referred to as a faster response time. Therefore, a contact agent can be preferred in particular for applications in which the test body is subject to rapid temperature changes that are to be detected promptly.

A contact agent can preferably be used in the case of a blind hole, since it cannot then run out in the insertion direction.

According to another embodiment, a measuring head at least partially recessed into the recess and having the temperature sensitive element may be molded into the recess by means of a potting compound.

According to an embodiment, a space between the measuring head and the walls of the recess can be at least partially filled with a potting compound.

Such a potting compound may comprise, for example, glass, epoxy resin, ceramic, silicone, polyurethane, or a mixture of combinations of these substances. The potting compound may also consist of such substances or combinations thereof.

The potting compound may be distinguished from a contact agent in that the potting compound is in a cured or solid state in the assembled test assembly.

By means of the potting compound, the fixation of the measuring head can be further improved and thus, in addition or as an alternative to other fixation possibilities described above, a fixation in a direction against the insertion direction can be achieved.

Furthermore, this can also result in better heat transport than is possible via air.

According to another embodiment of the test arrangement, the distance between the outer surface of a temperature sensitive element, which is for example the outer cover of a measuring head, and a point on the side wall of the recess is at most 0.6 mm.

This can minimize heat dissipation through a gap of certain size between the temperature sensitive element and a point on the sidewall in the direction out of the recess.

According to another embodiment, the temperature sensor is shaped to prevent tilting against the insertion direction.

An appropriately shaped or formed temperature sensor can reduce or prevent excessive wobble within the recess.

According to an embodiment, this effect can be achieved by the temperature sensor having a measuring head in which the temperature sensitive element is arranged and this measuring head having a form-fitting region which fits at least partially in a fitting manner into the shape of the recess.

Fitting into the recess can preferably be understood here as meaning that a distance between the form-fitting region and a wall of the recess is significantly smaller than the previously described 0.6 mm. For example, a distance between a point on the wall of the recess and the form-fitting region can be less than 0.1 mm.

According to an embodiment, the form-fitting region is in contact with a wall of the recess in at least one point, and preferably at more than one point.

By fitting the form-fitting region at least partially in a form-fitting manner into the recess, wobbling or tilting of a measuring head or the entire sensor in directions perpendicular to the insertion direction can be reduced or suppressed.

According to an embodiment, the form-fitting region can at least partially close the recess on the insertion side.

According to another embodiment, the form-fitting region can completely close the recess on the insertion side.

For example, in a corresponding measuring head, the temperature sensitive element can be arranged such that it is recessed deeper in the recess than the form-fitting region of the measuring head. By fitting the form-fitting region into the recess in a form-fitting manner, an at least partially enclosed measuring volume can thus be formed in the more interior part of the recess, thereby reducing disturbing heat loss from the measuring volume.

According to another embodiment of the test arrangement, a holding region of the temperature sensor can rest on the insertion side, i.e., on the insertion side of the test body. Further, the spring clamp may engage in a encompassing manner around the test body. This encompassing engagement can be done, for example, with a flexible area of the spring clamp. Furthermore, a lower support region of the spring clamp can rest on the outside of the test body. This outer side of the test body can preferably be arranged approximately opposite the insertion side. This contact can produce a clamping effect between the holding region of the temperature sensor and the support region of the spring clamp.

Such an arrangement in the test arrangement allows to arrange the temperature sensor at the test body in a particularly efficient and stable manner.

According to another embodiment, a temperature sensor is described in more detail. The temperature sensor may correspond to the temperature sensor as previously described in the context of the test arrangement, and may also have the features and advantages of the temperature sensor from the test arrangement, in addition to the features and advantages described below.

A temperature sensor is provided comprising a temperature sensitive element in a measuring head and further comprising a spring clamp. The measuring head and the spring clamp are connected to each other in a connection region of the temperature sensor. The measuring head extends from the connection region along an insertion direction of the measuring head. Furthermore, the connection region has a bearing surface, wherein the bearing surface can correspond, for example, to the previously described holding region. Furthermore, a spring part is arranged opposite the connection region. This can exert a spring action with respect to the connection region in the insertion direction.

Such a temperature sensor is well suited for efficient and simple installation in a test assembly, such as previously described. In particular, by the projecting of the measuring head away from the connection region in the insertion direction, insertion can be made into a recess in a test body.

Thus, such a temperature sensor provides in in its own right an advantage according to the invention.

Accordingly, an non-assembled ensemble comprising the temperature sensor and test body that can form a test assembly also has the corresponding advantages.

According to an embodiment, a sensor housing of the temperature sensor may be manufactured together with the spring clamp as a stamped and bent component. Preferably, the sensor housing of the temperature sensor can be manufactured together with the spring clamp as a common one-piece stamped and bent component.

According to an embodiment, the sensor housing here and in the following may be an enclosure of the sensor, for example enclosing or housing the electronics of the sensor. According to an embodiment, it may enclose all components except the measuring head. In this case, the measuring head may protrude from the housing. According to an alternative embodiment, an outer cover of the measuring head may be part of the sensor housing.

By manufacturing the sensor housing together with the spring clamp as a one-piece stamped and bent component, the temperature sensor can be easily manufactured.

A stamped and bent component is particularly suitable in the context of the present invention because the material of the stamped and bent component must have a certain flexibility and consequently must not be too elastic to allow easy deformation. This requirement may commonly run counter to the requirement for a spring clamp to have as much elasticity as possible. As according to the present invention, the contact pressure generated by the spring clamp serves only to prevent the temperature sensor from falling off the test body, a high elasticity of the spring is not absolutely necessary. Thus, materials suitable for punch bending can be used without further ado.

According to another embodiment of the temperature sensor, the temperature sensitive element comprises an NTC ceramic as well as metallisation.

Preferably, the temperature sensor can thus be an NTC temperature sensor.

According to another embodiment, an outer cover of the temperature sensitive element, which may preferably be, for example, an outer cover of the measuring head, may have an absorption value for thermal radiation greater than or equal to 0.5.

Basically it can be said that the higher the absorption value, the better the thermal connection of the measuring head to the test body can be. For example, an absorption value can be 0.7 or more.

Preferably, therefore, the outer cover can at least partially have the properties of a black radiator. This can be achieved, for example, by a corresponding coating or a corresponding coloring or painting.

Especially in a case where the measuring head or the temperature sensitive element has no direct contact with the walls of the recess of the test body, the temperature measurement can thus become faster and more accurate, since in addition to thermal conduction and convection via the air, thermal radiation from the walls of the recess to the sensor can also be efficiently exploited.

According to another embodiment, the above covers or closures of the recess may further provide a temperature shield against thermal radiation loss.

The invention is described in more detail below with reference to exemplary embodiments. These exemplary embodiments are shown in the following figures, which are not to scale. Lengths as well as relative and absolute dimensions can thus not be taken from the figures. Furthermore, the invention is also not limited to the following embodiments.

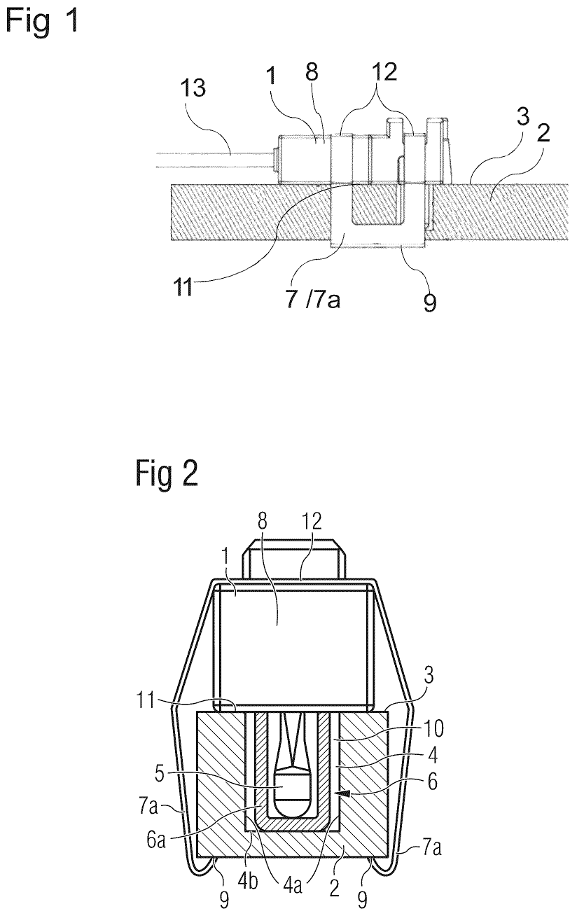

FIG. 1 shows a schematic side view of a first embodiment of a test arrangement.

FIG. 2 shows a schematic cross-section of the first embodiment of the test arrangement.

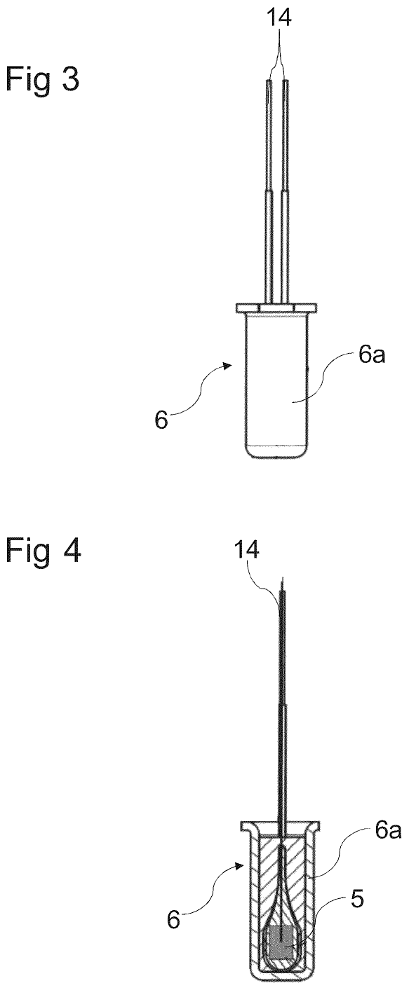

FIG. 3 shows a schematic side view of a measuring head for use in a temperature sensor in a test arrangement according to the first embodiment.

FIG. 4 shows a schematic cross-section of the measuring head shown in FIG. 3.

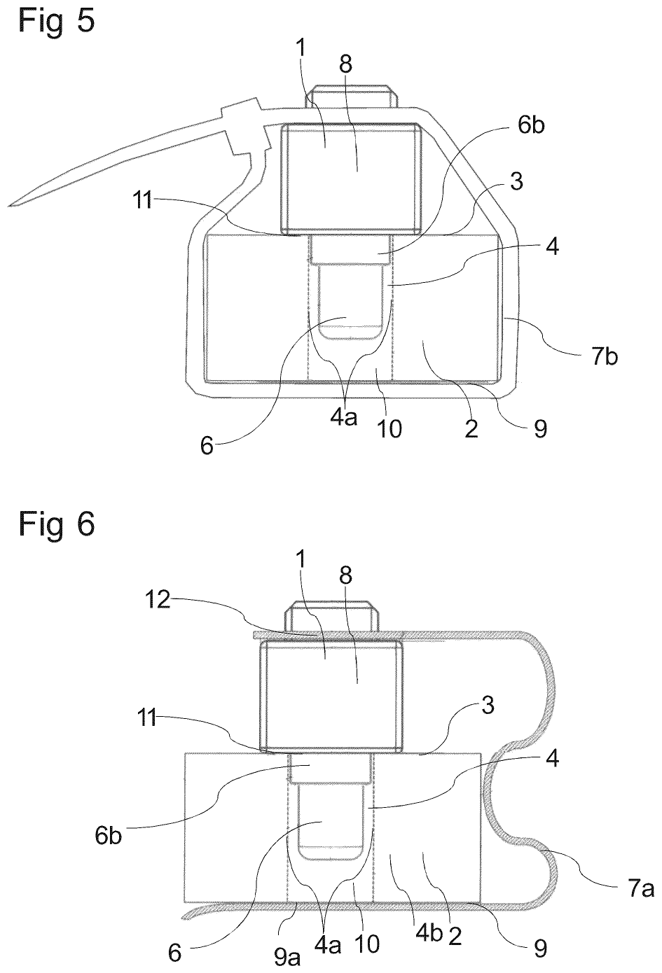

FIG. 5 shows a second exemplary embodiment of a test arrangement in schematic cross-section.

FIG. 6 shows a third exemplary embodiment of a test arrangement in schematic cross-section.

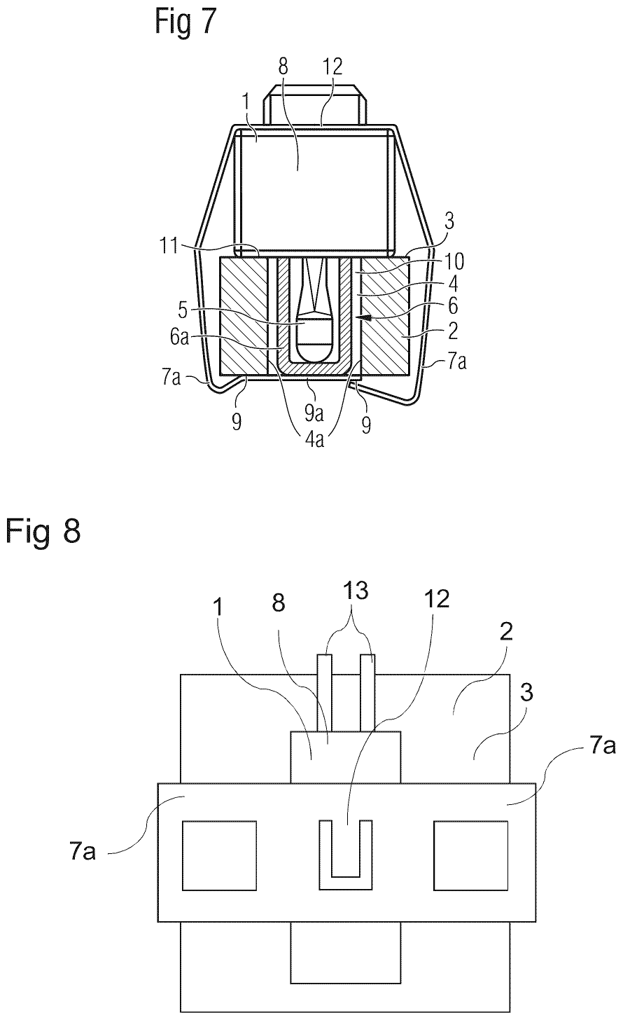

FIG. 7 shows a fourth exemplary embodiment of a test arrangement in schematic cross-section.

FIG. 8 shows a fifth exemplary embodiment of a test arrangement in schematic plan view.

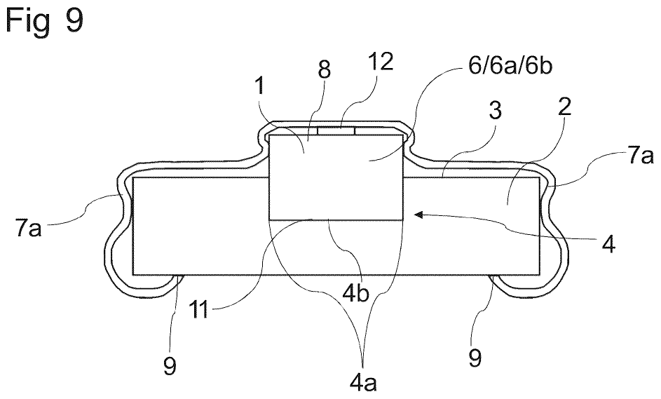

FIG. 9 shows the fifth exemplary embodiment of the test arrangement in schematic cross-section.

FIG. 1 shows a first exemplary embodiment of a test arrangement in schematic side view, whereby the test arrangement comprises a temperature sensor 1 and a test body 2.

The temperature sensor 1 rests on the test body 2, with a holding region 11 of the temperature sensor 1 resting on an insertion side 3 of the test body 2.

In the first exemplary embodiment, the test body is fixed by a spring clamp 7a as fastening device 7. The spring clamp 7a is arranged in a connection region 12 on the sensor housing 8 of the temperature sensor and engages around the test body 2 from the insertion side 3 and rests on the side opposite the insertion side 3 with a support region 9. Thus the spring clamp 7a produces a clamping effect against the insertion direction, i.e. in the present case between the holding region 11 and the support region 9.

The spring clamp can be made of a flexible metal or a flexible polymer.

External connections 13 lead to the temperature sensor 1 for external contacting.

The test body 2 shown is generally not further limited. In the present embodiment, it is preferably a metallic solid, which is elongated. For example, it can be a power rail of an electric motor in an electric vehicle.

Dimensions of the test body 2 are not further limited. For example, the power rail may have a cross-sectional area of 2.5 mm to 100 mm×5 mm to 10 mm, such as 30 mm×5 mm, 30 mm×10 mm, 40 mm×10 mm, 50 mm×10 mm, 60 mm×10 mm, 80 mm×10 mm, 100 mm×10 mm. In the automotive field, power rails may have a cross-sectional area of, for example, 2.5 mm×9 mm.

The material of the sensor housing 8 of the sensor 1 is not limited in specifically. It can be any metal. Alternatively, it may, for example, comprise or consist of a polymer. In addition to a polymer, the sensor housing 8 may also comprise glass, ceramic or carbon. These additives may be mixed with the polymer.

Possible polymers for a sensor housing can be selected from polyamide, such as PA6 or PA66, polypropylene, liquid crystal polymers, polyphthalamides, silicones, such as liquid silicones, and polyetheretherketone.

The length of the sensor housing, i.e. the extension in the longitudinal direction of an elongated test body, is not limited in detail. For typical power rails, for example, it can be between 5 and 30 mm.

FIG. 2 shows in schematic cross-section a further view of the first embodiment of the test arrangement. As can be seen, the spring clamps 7a are connected to the rest of the sensor housing 8 in a connection region 12.

A measuring head 6 is recessed into a recess 4 in the test body 2, projecting from the sensor housing 8 or protruding from the interior of the sensor housing 8. The measuring head 6 is completely recessed along the insertion direction.

The measuring head 6 has an outer cover 6a. The cover 6a of the measuring head can be metallic. It may preferably comprise copper, aluminum or steel or be composed of these materials. With respect to steel, galvanized or nickel-plated steel is preferred due to its corrosion resistance.

Alternatively, the cover 6a can comprise or consist of a polymer material. This can be, for example, the same polymer as for the housing 8. Optionally, the polymer can be mixed with an inorganic or ceramic material. This can be selected from boron nitride, aluminum nitride or carbon. These additives can increase the thermal conductivity of the plastic and thus enable rapid detection of temperature changes, i.e. a faster response time.

Alternatively, the cover 6a may be made of a ceramic. This may contain, for example, the following components: Aluminum, zinc, silicon, magnesium, titanium, zirconium, boron, nitrogen, oxygen and/or carbon.

In addition, the measuring head 6 or the cover 6a can have an absorption value for thermal radiation of at least 0.5. More preferred is an absorption value of 0.7 or above.

This can be done, for example, by a dark or black coating of the shell 6a.

Furthermore, the temperature sensitive element 5 is arranged in the measuring head 6, and is thus recessed in the recess 4. According to the first exemplary embodiment, the temperature sensitive element 5 is completely recessed in the recess.

The recess 4 has the side walls of the recess 4a, as well as the bottom of the recess 4b. The recess 4 is thus a blind hole. The recess 4 preferably has a round cross-section, but the shape can be chosen arbitrarily. The dimensions of the recess are not further limited. For typical power rails, the recess may have a diameter of from 2 mm to 15 mm, and preferably from 5 mm to 9 mm. The depth of the blind hole, i.e. a dimension in the insertion direction starting from the insertion side 3, can be 0.5 mm to 10 mm, and preferably 3 mm to 7 mm.

In the first exemplary embodiment, the test head 6 or cover 6a is in direct contact with the bottom 4b of the recess 4. This can thus promote heat flow between the test body 2 and the measuring head 6, or the temperature sensitive element 5 contained therein.

Alternatively, however, the measuring head 6 or the cover 6a according to the present invention may not touch the ground.

In the present first exemplary embodiment, there is no contact between the cover 6a of the measuring head 6 and the walls 4a of the recess 4. However, such contact may in principle also exist within the scope of the invention.

A space 10 exists between the outer shell 6a of the measuring head 6 and the walls 4a. In this space 10, the distance between the outer shell 6a of the measuring head 6 is preferably less than or equal to 0.6 mm. Even more preferably, this distance is less than or equal to 0.3 mm. The dimensions of the measuring head 6 can be aligned accordingly with the dimensions of the recess to meet this distance.

In the present first embodiment, the space 10 is filled by air. Alternatively, however, the space 10 can be filled by a contact agent, such as a thermally conductive paste. In this case, the contact agent has a greater thermal conductivity than that of air. In this way, heat conduction to the temperature sensitive element 5 can be improved.

Alternatively, the measuring head 6 in the recess 4 can also be enclosed by a potting compound, which is preferably cured solid in the assembled test arrangement. The potting compound can thus fill the space 10. The cured potting compound may increase heat conduction. Additionally, it may serve to fix the temperature sensor 1 to the test body 2 in addition to or instead of other fastening devices. For example, the potting compound may comprise glass, epoxy resin, ceramic, silicone, polyurethane, or a combination of these substances. The potting compound may also comprise such substances or combinations thereof.

As described above for FIG. 1, the spring clamps 7a between the holding region 11, which rests on the insertion side 3, and the support regions 9 of the spring clamps 7a produce a clamping effect against the insertion direction.

As described in the introduction, the clamping effect need not be so strong as to prevent slippage within the boundaries of recess 4, since a temperature measurement can be largely homogeneous within the boundaries of recess 4. In addition, the walls 4a of the recess 4 prevent the test body from slipping in a direction perpendicular to the insertion direction beyond the limits of the recess.

The flat support of the holding region 11 on the insertion side 3 as shown here, or generalized the precise fit, can also prevent wobbling or tilting of the temperature sensor 1 or the measuring head 4 within the recess 4 or against the insertion direction.

FIGS. 3 and 4 each show the measuring head 6, as it can be employed or installed in accordance with the first exemplary embodiment, for example, both in schematic side view in FIG. 3 and in schematic cross-section in FIG. 4. The measuring head 6 has a cover 6a, which preferably completely encloses and thus protects the temperature sensitive element 5. Internal contact elements 14 lead off from the temperature sensitive element 5. These can be routed in the test arrangement inside the sensor housing as part of the electronics and are preferably in direct or indirect electrical contact with the external connections 13 shown above.

FIG. 5 shows a second exemplary embodiment of a test arrangement in schematic cross-section.

The test body 2 in the test arrangement can largely correspond to that according to the first exemplary embodiment, wherein here, however, the test body 2 has as recess 4 hole going through the test body 2 starting from the insertion side 3 of the test body 2 through to an opposite side. The temperature sensor 1 may also largely have the features as described for the first embodiment example.

In contrast to the first embodiment example, however, no spring clamps are arranged on the temperature sensor 1 for fastening and fixing, but the fastening device in the present embodiment example is a cable tie 7b. In principle, spring clamps can also be mounted in addition to the cable tie 7b.

Here, the cable tie 7b is looped or tightened around the longitudinal axis of the test body 2.

The cable tie 7b provides a certain contact pressure for the temperature sensor on the test body and thus fixes the measuring head 6 in the recess 4 and prevents the test assembly from falling apart in a direction opposite to the insertion direction of the measuring head 6 in the recess 4.

Furthermore, the measuring head 6 has a form-fitting region 6b compared to the first embodiment. In this case, this form-fitting region 6b preferably has a shape complementary to the recess and fits in a mainly form-fitting manner the shape of the recess. A distance of the outer shell of the measuring head 6 in the form-fitting region 6b to at least one side wall 4a or preferably to all side walls 4a is significantly smaller than the above-mentioned 0.6 mm, which may otherwise preferably be present as a space between the measuring head and the wall. For example, the distance may be less than 0.1 mm. Even more preferably, the form-fitting region fits snugly and form-fittingly within the technically feasible accuracy in the recess without leaving a gap between the envelope 6a in the form-fitting region 6b and the wall 4a.

The form-fitting region 6b secures the measuring head 6 and the entire sensor 1 against tilting or slipping even within the limits of the recess 4. Furthermore, in the present embodiment, the form-fitting region 6b closes off the recess on the insertion side 3 at least partially and preferably completely.

In the present exemplary embodiment, a temperature sensitive element is arranged in the measuring head 6, whilst it is preferred that the temperature sensitive element is arranged below the form-fitting region 6b, i.e. within the measuring head 6 from the insertion side 3 in further inwards than the form-fitting region 6b.

FIG. 6 shows a schematic cross-section of a third exemplary embodiment of the test arrangement according to the invention.

All features of the third exemplary embodiment may correspond to those of the second exemplary embodiment, except for the fastening device. In the present embodiment, the fastening device is a single spring clamp 7a. This extends from a connection region 12, in which it is arranged on the sensor housing 8 and from which the measuring head 6 extends in the insertion direction. From this point, the spring clamp 7a embraces the test body 2 up to the side opposite the insertion side 3. In this way, the clamping effect is generated between the holding region 11, i.e. a region in which the sensor housing 8 rests on the insertion side 3, and a support region 9 of the spring clamp 7a.

Furthermore, in a region in which there is contact with the opening of the recess 4 on the side opposite the insertion side 3, the spring clamp 7a is shaped in such a way that the spring clamp 7a has or forms a sealing component 9a which at least partially covers the opening of the recess 4 or preferably closes it. That is, the shape of the sealing component 9a is preferably adapted to the shape of the immediate surrounding of the opening. Thus, for a flat surrounding, the sealing component 9a is preferably also flat. Thus, heat dissipation in this direction is hindered or prevented.

Preferably, the sealing component 9a is formed in extension or connection of the support region 9. In the present embodiment example, the support region 9 is formed over a major portion of the surface opposite the insertion side 3.

The single spring clamp also has the advantage that the test body 2 does not have to be accessible from all sides in order to attach the temperature sensor 1. For example, accessibility is only required from the insertion side 3 and the side of the test body 2 which is surrounded by the spring clamp 7a. The opposite side can remain completely inaccessible. The side opposite the insertion side 3 should be at least partially accessible in order to place the support region 9 on the test body.

FIG. 7 shows a schematic cross-section of a fourth exemplary embodiment of a test arrangement according to the invention. With the exception of the following features, this corresponds to the test arrangement as shown in FIG. 2.

In contrast to the first example shown in FIG. 2, the recess 4 is formed here as a continuous opening between the insertion side 3 and the side of the test body 2 opposite to the insertion side. Similarly as shown in the third exemplary embodiment, the fastening is carried out via spring clamps 7a, in this case realized by two spring clamps 7a. One of these spring clamps 7a is formed similarly or identically to the spring clamp in the first exemplary embodiment. The other spring clamp 7a is similar in design to the one in the third embodiment example. It not only secures the measuring head 6 and the temperature sensitive element 5 contained therein from moving and falling out of the recess 4 against the insertion direction, but also closes the through-hole-like recess on the side opposite the insertion side 3 with a sealing component 9a.

FIG. 8 shows a schematic top view of a fifth exemplary embodiment of a test arrangement. The fifth exemplary embodiment can basically have the features of the first or the further exemplary embodiments.

The special feature of the fifth embodiment is that the spring clamps 7a shown are manufactured together with the sensor housing 8 as a single common stamped and bent component.

Preferably, the spring clamps 7a have openings which can be largely rectangular, for example, as shown in the example. In this way the weight of the entire component can be reduced.

FIG. 9 shows a schematic cross-section of the fifth exemplary embodiment as shown in FIG. 8. As can be seen, according to the fifth exemplary embodiment, the entire sensor housing 8 of the sensor 1 can be formed as a measuring head 6, which extends in the insertion direction from a connection region 12 connecting the sensor housing 8 to the spring clamp 7a. That is, the part of the sensor housing 8 closer to the test body 2 or the recess 4 constitutes the measuring head 6. Furthermore, the measuring head 6 and a temperature sensitive element (not shown) contained therein are only partially recessed in the recess.

Unlike in the previous examples, the measuring head 6 also has the feature that the cover 6a of the measuring head 6 has contact with both the bottom 4b and the walls 4a of the recess 4. This full direct contact with all available inner surfaces of the recess 4 can improve a temperature transfer and allow a faster detection of temperature changes of the test body 2, i.e. an improved response time.

### LIST OF REFERENCE SIGNS

1 temperature sensor
2 test body
3 insertion side
4 recess
4a walls of the recess
4b bottom of the recess
5 temperature sensitive element
6 measuring head
6a cover of the measuring head
6b form-fitting region
7 fastening device
7a spring clamp
7b cable tie
8 sensor housing
9 Support region
9a sealing component
10 space
11 holding region
12 connection region
13 external connections
14 internal contact elements

1-20. (canceled)

21. A test arrangement comprising:
a test body; and
a temperature sensor for measuring a temperature of the test body,
wherein the test body has a recess open towards an insertion side of the test body, and wherein the temperature sensor has a temperature-sensitive element that is at least partially recessed in the recess by insertion.

22. The test arrangement according to claim 21, wherein the temperature sensitive element is completely recessed in the recess.

23. The test arrangement according to claim 21, further comprising a fastening device for fixing the temperature sensor against movements against an insertion direction.

24. The test arrangement according to claim 23, wherein the fastening device comprises a spring clamp.

25. The test arrangement according to claim 24, wherein a holding region of the temperature sensor rests on the insertion side of the test body, the spring clamp engages around the test body and, by resting a support region of the spring clamp on an outer side of the test body, produces a clamping effect between the holding region and the support region.

26. The test arrangement according to claim 23, wherein the fastening device comprises a cable tie.

27. The test arrangement according to claim 21, wherein the recess is a blind hole.

28. The test arrangement according to claim 21, wherein the recess has a further opening on an outer side of the test body which is covered by a sealing component of the temperature sensor.

29. The test arrangement according to claim 21, wherein the temperature sensor at least partially covers the recess on the insertion side of the test body.

30. The test arrangement according to claim 21, wherein a contact agent having better thermal conductivity than air fills a space between an outside of the temperature sensitive element and walls of the recess.

31. The test arrangement of claim 30, wherein the contact agent is a thermal paste.

32. The test arrangement according to claim 21, wherein a space between the measuring head and walls of the recess is at least partially filled with a potting compound.

33. The test arrangement according to claim 21, wherein a distance between an outside of the temperature sensitive element to a point on the side wall of the recess is at most 0.6 mm.

34. The test arrangement according to claim 21, wherein the temperature sensor is shaped in such a way that it is secured against tilting against the insertion direction.

35. The test arrangement according to claim 34, wherein a measuring head in which the temperature sensitive element is arranged has a form-fitting region which fits at least partially in a fitting manner into the shape of the recess.

36. The test arrangement according to claim 35, wherein the form-fitting region partially closes the recess on the insertion side.

37. A temperature sensor having a temperature sensitive element in a measuring head and a spring clamp, which are connected to one another in a connection region, the measuring head extending from the connection region in an insertion direction of the measuring head, the connection region having a bearing surface, and a spring part being arranged opposite the connection region, the spring part being configured to exert a spring effect with respect to the connection region in the insertion direction.

38. The temperature sensor according to claim 37, comprising a sensor housing which is manufactured together with the spring clamp as a stamped and bent component.

39. The temperature sensor according to claim 37, wherein the temperature sensitive element comprises an NTC-ceramic and a metallization.

40. The temperature sensor according to claim 37, wherein an outer cover of the temperature sensitive element has an absorption value for thermal radiation of more than 0.5.
